(19) United States
(12) Patent Application Publication
(10) Pub. No.: US 2016/0311259 A1
(43) Pub. Date: Oct. 27, 2016

(54) TIRE INNER LINER AND PNEUMATIC TIRE

(71) Applicants: TOYO TIRE & RUBBER CO., LTD., Osaka-shi (JP); TOYOBO CO., LTD., Osaka-shi (JP)

(72) Inventors: Toshiki Shimizu, Osaka-shi (JP); Tetsuya Tsuboi, Osaka-shi (JP); Tatsuya Endo, Osaka-shi (JP); Koji Kobayashi, Ohtsu-shi (JP); Momoko Daitoku, Ohtsu-shi (JP)

(73) Assignees: TOYO TIRE & RUBBER CO., LTD., Osaka-shi (JP); TOYOBO CO., LTD., Osaka-shi (JP)

(21) Appl. No.: 15/104,361

(22) PCT Filed: Dec. 5, 2014
(86) PCT No.: PCT/JP2014/006107

§ 371 Date: Jun. 14, 2016

(30) Foreign Application Priority Data
Dec. 17, 2013 (JP) 2013-260331

(51) Int. Cl. B60C 5/14; B29D 30/06; B60C 1/00

(52) U.S. Cl. CPC B60C 5/14; B60C 1/0008; B29D 30/0681; B29D 2030/0682; B29K 2067/006

(57) ABSTRACT

To provide a tire inner liner formed by using a cylindrical film (10) including a thermoplastic material and obtained by inflation molding, in which a ratio of breaking strength in a tire width direction (14) to breaking strength in a tire circumferential direction (18) of the cylindrical film (10) is from 1.35 to 1.80. A pneumatic tire (1) is obtained by extruding and molding the cylindrical film (10) in which a ratio of breaking strength in an extrusion direction (12) to breaking strength in a direction perpendicular to the extrusion direction (16) is from 1.35 to 1.80 by inflation molding using a thermoplastic material, forming a green tire by placing the obtained cylindrical film (10) on a forming drum so that the extrusion direction (12) becomes the tire width direction (14), and vulcanizing and molding the green tire.

### TECHNICAL FIELD

The present invention relates to a tire inner liner and a pneumatic tire using the same.

### BACKGROUND ART

An inner liner is provided as an air permeation suppression layer in an inside surface of a pneumatic tire for keeping an air pressure of the tire in a fixed pressure. Such inner liner is generally formed of a rubber layer such as a butyl rubber or a halogenated butyl rubber, which is hardly permeated by a gas. The use of a film made of resin which can be reduced in thickness is considered for reducing the weight of the tire.

For example, there is disclosed in PTL 1, a pneumatic tire using a cylindrical thermoplastic film having no joint fabricated by an inflation molding method as an inner liner. In PTL 2, there are disclosed that a thermoplastic elastomer film is fabricated by using a thermoplastic elastomer composition containing a crosslinked elastomer component as a dispersed phase in a continuous phase of a thermoplastic resin by using cylindrical inflation molding, that biaxial stretching is performed with a blow ratio of 2 or more is performed at the inflation molding, and that the obtained elastomer film is used for the inner liner of the pneumatic tire. In PTL 3, there are disclosed that a tire inner liner is fabricated by the inflation molding method using a thermoplastic elastomer containing a thermoplastic resin and an elastomer component and that a ratio of breaking strength of the inner liner between a tire width direction and a peripheral direction is respectively from 0.75 to 1.3.

### CITATION LIST

### Patent Literature

PTL 1: JP-A-8-258506
PTL 2: JP-A-2006-315339
PTL 3: JP-A-2007-030691

### SUMMARY OF INVENTION

### Technical Problem

It has been known that the cylindrical film including the thermoplastic material and obtained by the inflation molding is used as the tire inner liner as described above, in which the inner liner having an orientation ratio as the ratio of breaking strength between the tire width direction and the peripheral direction is close to 1 has been used.

However, it has been found that it is difficult to realize both tire formability and tire durability in the inner liner having the orientation ratio close to 1.

In view of the above, an object of the present invention is to provide a tire inner liner and a pneumatic tire using the same capable of realizing both tire formability and tire durability.

### Solution to Problem

According to an embodiment of the present invention, there is provided a tire inner liner formed using a cylindrical film that includes a thermoplastic material and is obtained by inflation molding, in which a ratio of breaking strength in a tire width direction to breaking strength in a tire circumferential direction of the cylindrical film is from 1.35 to 1.80. A pneumatic tire according to an embodiment of the present invention includes the tire inner liner.

According to an embodiment of the present invention, there is provided a method of manufacturing a pneumatic tire including the steps of extruding and molding a cylindrical film in which a ratio of breaking strength in an extrusion direction to breaking strength in a direction perpendicular to the extrusion direction is from 1.35 to 1.80 by inflation molding using a thermoplastic material, forming a green tire by placing the obtained cylindrical film on a forming drum so that the extrusion direction becomes a tire width direction, and vulcanizing and molding the green tire.

### Advantageous Effects of Invention

According to the embodiment of the invention, the orientation direction of the cylindrical film obtained by inflation molding is approximately parallel to a load direction of the tire, therefore, tire durability is excellent. Though the cylindrical film is expanded mainly in the tire circumferential direction at the time of forming the tire, the tire circumferential direction is a direction perpendicular to the orientation direction of the cylindrical film, and a modulus in a direction perpendicular to the orientation direction is lower than a modulus in a direction parallel to the orientation direction, therefore, the film is easily expanded in the tire circumferential direction and the tire formability is excellent. Accordingly, both the tire formability and the tire durability can be realized.

### BRIEF DESCRIPTION OF DRAWINGS

FIG. 1 is a cross-sectional view of a pneumatic tire according to an embodiment.

FIG. 2 is conceptual diagrams showing a relation between a tire circumferential direction and an orientation direction of a cylindrical film according to the embodiment.

FIG. 3 is a conceptual diagram showing a relation between a tire load direction and the orientation direction of the cylindrical film according to the embodiment.

FIG. 4 is a conceptual diagram showing a relation between a tire load direction and an orientation direction of a film according to a comparative example.

### DESCRIPTION OF EMBODIMENTS

Hereinafter, embodiments of the present invention will be explained in reference to the drawings.

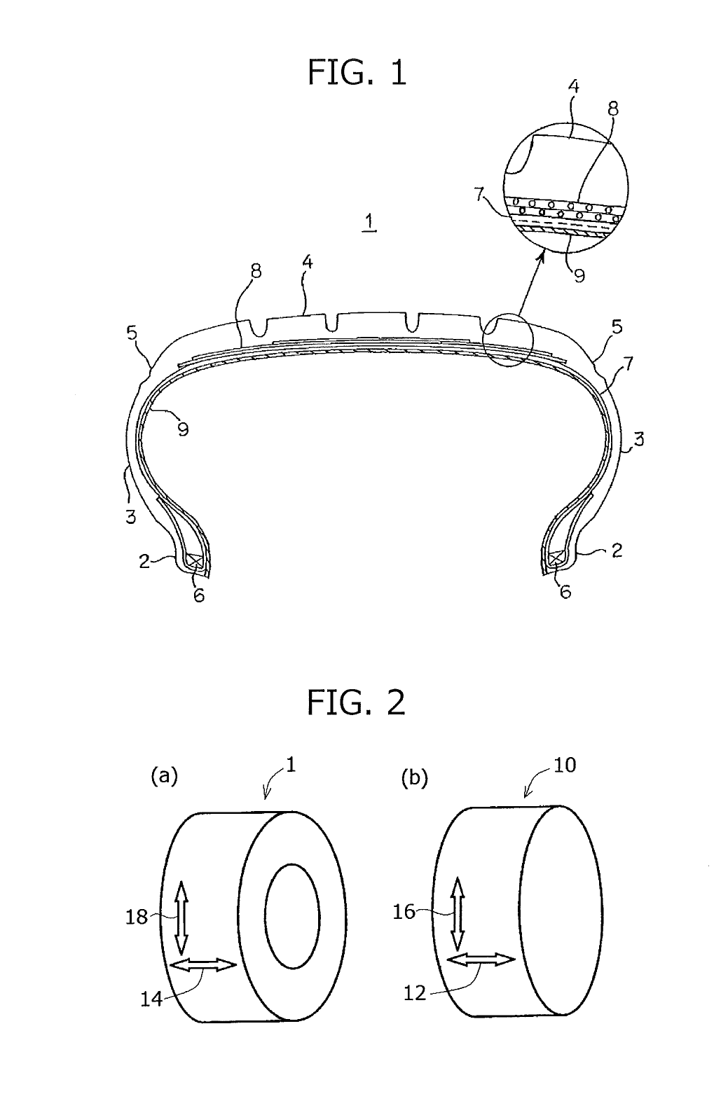

FIG. 1 is a cross-sectional view of a pneumatic tire 1 according to an embodiment. As shown in the drawing, the pneumatic tire 1 includes a right-and-left pair of bead portions 2, 2 to be rim-assembled, a pair of sidewall portions 3, 3 extending from the bead portions 2 to the outside of a tire radial direction, a tread portion 4 provided between the pair of sidewall portions 3, 3 and contacting a road surface, and a right-and-left pair of shoulder portions 5, 5 forming boundary areas between the tread portion 4 and the sidewall portions 3, 3 on both sides.

In the pair of bead portions 2, 2, ring-shaped bead cores 6 are respectively embedded. A carcass ply 7 using an organic fiber cord is locked with folded around the bead cores 6, 6 and is provided so as to bridge between the right and left bead portions 2, 2 in a toroidal manner. On an outer peripheral side of the carcass play 7 in the tread portion 4, a belt 8 formed of two pieces of crossing belt plies using a rigid tire cord such as a steel cord or aramid fibers is provided.

An inner liner 9 is provided inside the carcass ply 7 over the entire inner surface of the tire. That is, the inner liner 9 is placed so as to cover the entire inner surface of the tire from the tread portion 4 toward the bead portions 2, 2 through the shoulder portions 5, 5 and the sidewall portions 3, 3 on the right and left both sides. In the embodiment, an air permeation resistant film formed of a thermoplastic material is used as the inner liner 9. The inner liner 9 is adhered to an inner surface of the carcass ply 7 as shown in an enlarged view in FIG. 1, and more specifically, the inner liner 9 is adhered to an inner surface of a topping rubber layer covering the cord of the carcass ply 7.

As a material of the film forming the inner liner 9, various types of thermoplastic resins and/or thermoplastic elastomers can be used.

As specific examples of thermoplastic resins, polyamide-based resins such as nylon 6 and nylon 66, polyester-based resins such as polybutylene terephthalate (PBT) and polyethylene terephthalate (PET), polynitrile-based resins such as polyacrylonitrile (PAN) and polymethacrylonitrile, cellulose-based resins such as cellulose acetate and cellulose acetate butyrate, fluorine-based resins such as polyvinylidene fluoride (PVDF) and polyvinyl fluoride (PVF), imide-based resins such as aromatic polyimide (PI), polyvinyl alcohol and so on can be cited, and above resins can be used independently as well as used by combining two or more kinds of resins.

As thermoplastic elastomers, block copolymers having hard segments forming a thermoplastic frozen phase or crystal phase and soft segments indicating rubber elasticity can be used. For example, a polyester-based elastomer having polyester as a hard segment, a polyamide-based elastomer having polyamide as a hard segment, a polystyrene-based elastomer having polystyrene as a hard segment, a polyolefin-based elastomer having polyethylene or a polypropylene as a hard segment, a polyurethane-based elastomer having a urethane structure as a hard segment and so on can be cited, and above elastomers can be used independently as well as used combining two or more kinds of elastomers. Moreover, materials obtained by blending the block copolymers with a rubber component or a resin component can be also used as thermoplastic elastomers. Furthermore, elastomers having a sea-island structure obtained by blending the thermoplastic resins with a rubber component may be used as thermoplastic elastomers.

Various types of additives such as fillers and compatibilizers may be blended with the above thermoplastic resins or the thermoplastic elastomers. The same applies to the rubber component included in the thermoplastic elastomer. When these materials are blended, various types of kneading machines such as a twin-screw extruder, a screw extruder, a kneader and a Banbury mixer can be used.

As one embodiment, a film formed of a continuous phase (matrix phase) of a thermoplastic elastomer (A) and a dispersed phase (domain phase) of a rubber (B) is preferably used for the inner liner 9. The material hardly permeated by air as compared with rubber is selected as the thermoplastic elastomer which forms the continuous phase, thereby improving the air permeation resistance of the film. As the thermoplastic elastomer is generally softer than the thermoplastic resin, a softer film can be fabricated without substantially increasing a ratio of the rubber forming the dispersed phase. Therefore, both the air permeation resistance and flexibility can be easily realized.

As the thermoplastic elastomer (A) forming the continuous phase, the elastomers enumerated above can be used, and a thermoplastic polyester-based elastomer (A1) is preferably used from a viewpoint of heat resistance.

In the thermoplastic polyester-based elastomer (A1), polyester as the hard segment is formed by making a dicarboxylic acid reacting with a diol. As the dicarboxylic acid, an aromatic dicarboxylic acid is preferably used. As the aromatic dicarboxylic acid, a normal aromatic dicarboxylic acid is widely used. As a principal aromatic dicarboxylic acid, a terephthalic acid or a naphthalene dicarboxylic acid is preferable, though not particularly limited. As other acid components, aromatic dicarboxylic acids such as an isophthalic acid, a diphenyl dicarboxylic acid and a 5-sodium sulfoisophthalic acid, alicyclic dicarboxylic acids such as a cyclohexanedicarboxylic acid and a tetrahydrophthalic anhydride, aliphatic dicarboxylic acids such as a succinic acid, a glutaric acid, an adipic acid, an azelaic acid, a sebacic acid, a dodecanedioic acid, a dimer acid and a hydrogenated dimer acid and so on can be cited. These other acid components are used in a range where a melting point of the polyester-based elastomer is not significantly decreased, and a quantity thereof is preferably lower than 30 mol %, and more preferably lower than 20 mol % of the entire acid component.

As the diol, an aliphatic or alicyclic diol can be used. As the aliphatic or alicyclic diol, a common aliphatic or alicyclic diol is used, and it is preferable to use alkylene glycols having from 2 to 8 carbon atoms principally, though not particularly limited. Specifically, an ethylene glycol, a 1,3-propylene glycol, a 1,4-butanediol, a 1,6-hexanediol, a 1,4-cyclohexanedimethanol and so on can be cited. Among them, the 1,4-butanediol and/or the 1,4-cyclohexanedimethanol are most preferable.

As components forming the polyester as the hard segment, components having a butylene terephthalate unit, a butylene isophthalate unit and/or a butylene naphthalate unit are preferable from viewpoints of physicality, formability and cost performance. In the case of the naphthalate unit, a 2,6-form is preferable.

In the thermoplastic polyester-based elastomer (A1), examples of the constituent component of soft segment include a polyester, a polyether, a polycarbonate and so on. Among them, a polyester-based elastomer having polycarbonate as the soft segment is preferably used as both air permeation resistance and flexibility are well balanced. As a polycarbonate, an aliphatic polycarbonate diol produced from a carbonic ester such as a dimethyl carbonate or a diethyl carbonate and a aliphatic glycol having from 2 to 12 carbon atoms and so on can be cited.

As the thermoplastic polyester-based elastomer (A1), it is particularly preferable to use the elastomer having a hard segment principally comprising polybutylene terephthalate and a soft segment comprising aliphatic polycarbonate. A ratio between the hard segment and the soft segment is not particularly limited in the thermoplastic polyester-based elastomer (A1), however, a mass ratio is preferably hard segment:soft segment=30:70 to 95:5, and more preferably, in a range of 40:60 to 90:10.

The thermoplastic polyester-based elastomer (A1) may be a block copolymer having the hard segment and the soft segment, and may be an elastomer obtained by blending a resin forming an additional hard segment such as polybutylene terephthalate with the block copolymer, as well as an elastomer obtained by further copolymerizing the resin with the block copolymer. In this case, it is also possible to generate a copolymer by melting and kneading the block copolymer and the resin such as polybutylene terephthalate. Accordingly, the copolymer obtained by melting and kneading as well as the copolymer obtained only by blending may be adopted.

As the rubber (B) forming the dispersed phase, various types of rubbers commonly used by being crosslinked (vulcanized) are adopted. For example, diene-based rubbers and hydrogenated rubbers thereof such as a natural rubber (NR), an epoxidized natural rubber (ENR), an isoprene rubber (IR), a styrene-butadiene rubber (SBR), a butadiene rubber (BR), a nitrile rubber (NBR), a hydrogenated nitrile rubber (H-NBR) and a hydrogenated styrene-butadiene rubber; olefin-based rubbers such as an ethylene-propylene rubber (EPDM), a maleic acid-modified ethylene-propylene rubber, a maleic acid-modified ethylene-butylene rubber, a butyl rubber (IIR) and an acrylic rubber (ACM); halogen-containing rubbers such as a halogenated butyl rubber (for example, a brominated butyl rubber (Br-IIR), a chlorinated butyl rubber (Cl-IIR)), a chloroprene rubber (CR) and a chlorosulfonated polyethylene; and a silicon rubber, a fluororubber, a polysulfide rubber and so on can be cited. Any one of these kinds of rubbers may be used independently as well as used by combining two or more kinds of rubbers. In the above rubbers, it is preferable to use at least one kind selected from the butyl rubber (IIR), the halogenated butyl rubber such as the brominated butyl rubber (Br-IIR), the nitrile rubber (NBR) and the hydrogenated nitrile rubber (H-NBR) from a viewpoint of the air permeation resistance.

The rubber (B) forming the dispersed phase may be any one kind of or a blend of two kinds or more of the above-described rubber polymers. Various kinds of compounding agents commonly compounded to a rubber composition such as a filler, a softener, an antioxidant, a processing aid and a crosslinking agent may be added to those rubbers. That is, the rubber (B) to be the dispersed phase may be a rubber formed of a rubber composition obtained by adding various compounding agents to the rubber.

A compounding ratio (a ratio as polymer components except compounding agents such as the filler) between the thermoplastic elastomer (A) and the rubber (B) is not particularly limited, and for example, from 90/10 to 30/70 in mass ratio (A)/(B), and more preferably, from 70/30 to 40/60.

The thermoplastic material forming the film according to the embodiment may contain a compatibilizer in addition to the thermoplastic elastomer (A) and the rubber (B). The compatibilizer reduces an interfacial tension between the thermoplastic elastomer (A) and the rubber (B) to compatibilize the both, which can reduce the particle size of the dispersed phase and improve the film formability. As compatibilizers, a graft copolymer with a polycarbonate resin as a main chain and with a modified acrylonitrile-styrene copolymer resin as a side chain, copolymers having an ethylene main chain backbone and a side chain containing an epoxy group (for example, ethylene copolymers containing the epoxy group such as an ethylene-glycidyl (meth)acrylate copolymer (namely, an ethylene-glycidyl methacrylate copolymer and/or an ethylene-glycidyl acrylate copolymer)), a graft copolymer with the ethylene-glycidyl (meth)acrylate as a main chain and with a polystyrene resin as a side chain and so on can be cited. A compounding amount of the compatibilizer is not particularly limited, and can be from 0.5 to 10 parts by mass, per 100 parts by mass of the total amount of the thermoplastic elastomer (A) and the rubber (B).

As a more preferred embodiment, a film obtained by melting and kneading the thermoplastic elastomer (A) and the rubber (B) with a crosslinking agent so that the rubber is dynamically crosslinked by the crosslinking agent is used as the inner liner 9. The rubber (B) is dynamically crosslinked (TPV), thereby reducing the particle size of the dispersed phase and improving flexibility.

As crosslinking agents for dynamically crosslinking the rubber, vulcanizing agents such as sulfur and sulfur-containing compounds, vulcanization accelerators, phenolic resins and so on can be cited. The phenolic resins are preferably used from a viewpoint of heat resistance. As phenolic resins, resins obtained by condensation reaction of phenols and formaldehyde can be cited, and more preferably, an alkyl phenol-formaldehyde resin is used. A compounding amount of the crosslinking agent is not particularly limited as long as they can crosslink the rubber (B) properly, but the amount is preferably from 0.1 to 10 parts by mass, per 100 parts by mass of the rubber (B) (the amount of the polymer except the compounding agents such as the filler).

The film formed of the continuous phase of the thermoplastic elastomer (A) and the dispersed phase of the rubber (B) is preferably an air permeation coefficient of 5×10¹³ fm²/Pa·s or less for enhancing the weight reducing effect of the tire. More preferably, the air permeation coefficient is 4×10¹³ fm²/Pa·s or less. The lower limit is not particularly limited, however, 0.5×10¹³ fm²/Pa·s or more is practically preferable. Here, the air permeation coefficient is a value measured under conditions of a test gas:air and a test temperature: 80° C. based on JIS K7126-1 “Plastics-Film and sheeting-Determination of gas transmission rate-Part 1: Differential-pressure method”.

It is also preferable that the film has 10 MPa or less in 10% modulus for enhancing follow-up ability to improve workability at the time of tire forming and enhancing tire durability. More preferably, the 10% modulus is 8 MPa or less, and further preferably 6 MPa or less. The lower limit is not particularly limited, however, 3 MPa or more is preferable. Here, the 10% modulus is a tensile stress measured based on a tensile test of JIS K6251 in 23° C. at the time of 10% stretch (punched by No. 3 dumbbell), which is a tensile stress measured in a direction perpendicular to an extrusion direction of the film (tire circumferential direction).

In the embodiment, the cylindrical film obtained by the inflation molding is used as the film forming the inner liner 9. That is, the cylindrical film for the inner liner is obtained by melding and kneading the thermoplastic materials and by extrusion-molding the obtained molten material into the cylindrical shape by using an extruder provided with an inflation die such as a ring die. At that time, the inflation molding is performed so that the cylindrical film has a given orientation by setting an extrusion direction to an orientation direction, that is, the film has the orientation in which breaking strength becomes the maximum in the extrusion direction and becomes the minimum in a direction perpendicular to the extrusion direction in the embodiment.

In the cylindrical film according to the embodiment, a ratio of a breaking strength in the extrusion direction to a breaking strength in the direction perpendicular to the extrusion direction, that is, a ratio (orientation ratio) of the breaking strength, “extrusion direction”/“direction perpendicular to the extrusion direction” is from 1.35 to 1.80. The cylindrical film is set so that the extrusion direction becomes a tire width direction in the embodiment. Therefore, a ratio of the breaking strength in the tire width direction to the breaking strength in the tire circumferential direction, that is, a ratio of the breaking strength, “tire width direction”/“tire circumferential direction” is from 1.35 to 1.80 in the tire inner liner. As the orientation ratio of the breaking strength is 1.35 or more, both the tire formability and the tire durability can be realized. When the orientation ratio of the breaking strength exceeds 1.80, a crack extending in the tire width direction easily occurs while the tire is running. The orientation ratio of the breaking strength is preferably from 1.35 to 1.50.

The breaking strength of the cylindrical film in the extrusion direction (tire width direction) is preferably 15 MPa or more, and more preferably 18 MPa or more. The upper limit of the breaking strength in the extrusion direction is not particularly limited, but the breaking strength is preferably 25 MPa or less, and more preferably 22 MPa or less.

Here, the breaking strength of the film is a tensile strength measured based on the tensile test of JIS K6251 in 23° C. (punched by No. 3 dumbbell), which is measured in the extrusion direction of the film (tire width direction) and the direction perpendicular to the extrusion direction (tire circumferential direction).

In the cylindrical film according to the embodiment, a ratio of the 10% modulus in the extrusion direction to the 10% modulus in the direction perpendicular to the extrusion direction, that is, a ratio (orientation ratio) of the 10% modulus, “extrusion direction”/“direction perpendicular to the extrusion direction” is preferably from 1.1 to 1.5. The cylindrical film is set so that the extrusion direction becomes the tire width direction in the embodiment. Therefore, a ratio of 10% modulus in the tire width direction to 10% modulus in the tire circumferential direction, namely, a ratio of the 10% modulus, “tire width direction”/“tire circumferential direction” is preferably from 1.1 to 1.5. The film is expanded mainly in the tire circumferential direction at the time of tire forming. The 10% modulus in the tire circumferential direction is lower when the orientation ratio of the 10% modulus is higher, therefore, the tire forming is easier. It is preferable that the orientation ratio of the 10% modulus is from 1.1 to 1.3.

As a condition of the inflation molding, a blow ratio is preferably from 1.2 to 1.8 for obtaining the above orientation ratio. Here, the blow ratio is a ratio between a diameter of a ring die and a diameter of the expanded cylindrical film in the inflation method, which is referred to also as blowup rate. The formability in the inflation molding can be improved by setting the blow ratio to 1.2 or more. When the blow ratio is 1.8 or less, the orientation ratios in the breaking strength and the 10% modulus can be increased. More preferably, the blow ratio is from 1.2 to 1.6.

Also as a condition of the inflation molding, a taking-up speed of the cylindrical film extruded from the extruder is preferably from 1 to 10 m/minute, and more preferably 2 to 8 m/minute. A temperature in the molding may be a temperature in which the thermoplastic material is melted or more.

As a preferred embodiment, when a dynamically crosslinked material of the thermoplastic elastomer (A) and the rubber (B) is used as the thermoplastic material, the cylindrical film is fabricated in the following manner. That is, the thermoplastic elastomer (A) and the rubber (B) are melted and kneaded with a crosslinking agent, and the rubber (B) is dynamically crosslinked by the crosslinking agent to obtain the thermoplastic material including the rubber (B) as the dispersed phase in the continuous phase of the thermoplastic elastomer (A). After that, the film is formed by the inflation molding while melting the obtained thermoplastic material.

A thickness of the cylindrical film obtained by the inflation molding is not particularly limited, and may be set to, for example, from 0.02 to 2.0 mm, and more preferably set to from 0.05 to 1.0 mm.

An obtained cylindrical film 10 is set in the tire 1 so that the width direction thereof (namely, an extrusion direction 12) corresponds to a tire width direction 14 and a circumferential direction (namely, a direction 16 perpendicular to the extrusion direction) corresponds to a tire circumferential direction 18 as shown in FIG. 2. In more detail, the cylindrical film 10 is attached to an outer periphery of a forming drum as a member forming the inner liner 9 so that the extrusion direction 12 corresponds to the tire width direction 14 at the time of forming a green tire. The carcass ply 7 is adhered thereto, and further, the belt 8 and respective tire members such as a tread rubber and a sidewall rubber are adhered so as to be overlapped, and these members are inflated to fabricate a green tire (unvulcanized tire), and the pneumatic tire 1 is obtained by vulcanizing and molding the green tire in a mold.

In the obtained pneumatic tire 1, the inner liner 9 is set so that the extrusion direction (namely, the orientation direction) 12 of the cylindrical film 10 corresponds to the tire width direction 14. Accordingly, the orientation direction 12 of the cylindrical film 10 is parallel to a tire meridian direction, specifically, the orientation direction 12 is arranged so as to be approximately parallel to the tire width direction in the tread portion 4, and the orientation direction 12 is arranged so as to be approximately parallel to the tire radial direction in the shoulder portion 5, the sidewall portion 3 and the bead portion 2.

[Operations and Effects]

Next, operations and effects of the above embodiment will be explained.

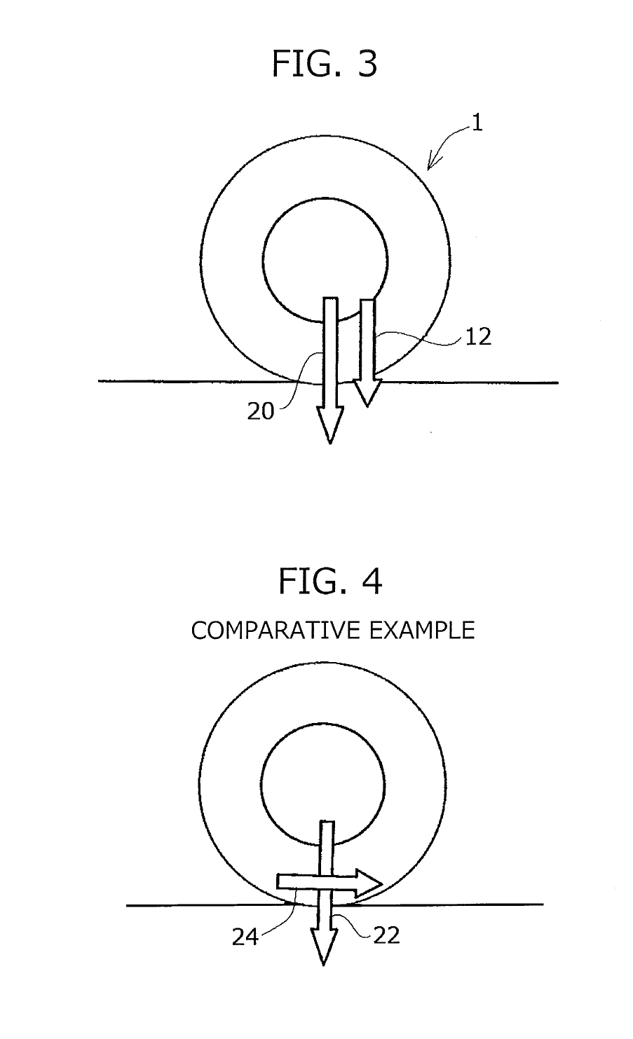

In the pneumatic tire 1 according to the embodiment, the inner liner 9 is arranged so that the orientation direction 12 of the cylindrical film 10 corresponds to the tire width direction 14 and the orientation direction 12 is approximately parallel to the tire radial direction in the area from the shoulder portion 5 to the sidewall portion 3. The tire repeats a deformation in which the area from the shoulder portion 5 to the sidewall portion 3 is bent by a load and returns to the original shape at the time of rolling. That is, bending deformation of the tire occurs in the area from the shoulder portion 5 to the sidewall portion 3 in the load direction. In the embodiment, in the area where such bending deformation is performed, a load direction 20 and the orientation direction 12 of the cylindrical film 10 are approximately parallel as shown in FIG. 3. Accordingly, a fracture due to bending deformation at the time of rolling the tire hardly occurs in the inner liner 9 and the durability is improved.

On the other hand, a pneumatic tire according to a comparative example is considered, in which a cylindrical film is fabricated using the film having the orientation in the extruding direction formed by a T-die extrusion method so that the extrusion direction becomes a tire circumferential direction and is used as the inner liner. In the tire according to the comparative example, an orientation direction (extrusion direction) 24 of the film is perpendicular to a tire load direction 22 as shown in FIG. 4. Accordingly, when the area from the shoulder portion to the sidewall portion is bent and deformed in the load direction at the time of rolling the tire, a fracture extending in the tire circumferential direction easily occurs in the film of the inner liner in the vicinity of the shoulder portion, which impairs the durability.

According to the embodiment, the fracture due to the bending deformation at the time of rolling the tire hardly occurs. When the film formed by the T-die extrusion method is used, a process of bonding end portions of the film to make the cylindrical shape is necessary after the extrusion molding. However, the film is extruded in the cylindrical shape in the inflation molding used in the embodiment, therefore, such bonding process is not necessary. In the case of the T-die extrusion method, for example, when the end portions are bonded by using heat sealing, the thickness of film approximately doubles at a joint, the probability that the joint is damaged in a tire durability test increases and the durability is damaged. On the other hand, the cylindrical film having no joint can be obtained by the inflation molding according to the embodiment, which improves the durability also from this point of view.

Also according to the embodiment, the tire formability is also excellent as the cylindrical film having the given orientation is used as the inner liner. Specifically, the cylindrical film used as the inner liner at the time of forming the green tire is expanded mainly in the tire circumferential direction. At this time, the tire circumferential direction is the direction perpendicular to the orientation direction of the cylindrical film in the embodiment, the cylindrical film is easily expanded in the tire circumferential direction and the green tire is easily formed.

The pneumatic tire according to the embodiment is not limited to the pneumatic tire for a passenger car but also can be applied to various types of tires for automobiles including tires of trucks or buses, which are for heavy loads, and can be applied to various types of tires such as tires for two-wheeled vehicles including bicycles.

### EXAMPLES

Hereinafter, the present invention will be specifically explained based on examples, and the present invention is not limited by these examples.

### Examples 1 to 3, Comparative Examples 1, 2

50 parts by mass of a thermoplastic polyester-based elastomer B, 50 parts by mass of a butyl rubber (“IIR268” manufactured by Exxon Mobil Chemical Company), 5 parts by mass of a compatibilizer (“BONDFAST E” manufactured by SUMITOMO CHEMICAL Co., Ltd.), 2.5 parts by mass of a phenol-based resin (alkyl phenol/formaldehyde condensation product “TACKIROL 201” manufactured by Taoka Chemical Co., Ltd) as a crosslinking agent were prepared, which were dynamically crosslinked by being melted and kneaded by a twin-screw kneading machine (manufactured by Research Laboratory of Plastic Technology Co., Ltd.) so as to be pelletized. 2.5 parts by mass of a resorcin-formaldehyde condensation product (modified resorcin-formaldehyde condensation product “SUMIKANOL 620” manufactured by Taoka Chemical Co., Ltd) as an adhesive was added to 107.5 parts by mass of the obtained dynamically crosslinked material by using the twin-screw kneading machine, and these materials were melted and kneaded to obtain pellets.

The obtained pellets were extruded into a cylindrical film having a thickness of 0.2 mm and a diameter of 360 mm by inflation molding using a single screw extruder to which a ring die for inflation was attached. In the extrusion molding, the size of the ring die was changed with respect to respective blow ratios so as to form the cylindrical film having the above size. The molding temperature at the time of inflation molding was 240° C., and the blow ratios and the taking-up speeds were as shown in Table 1. All the obtained cylindrical films had the thermoplastic polyester-based elastomer as the continuous phase and the dynamically crosslinked material of butyl rubber as the dispersed phase. Note that the cylindrical film was not able to be obtained by inflation molding in Comparative Example 1 as the blow ratio was too low.

### Example 4

The pellets were obtained by the same method as the embodiments 1 to 3 described above except that the thermoplastic polyester-based elastomer A was used instead of using the thermoplastic polyester-based elastomer B. Extrusion molding was performed by using the obtained pellets by the inflation molding (the blow ratio and the taking-up speed were as shown in Table 1). The obtained cylindrical film had the thermoplastic polyester-based elastomer as the continuous phase and the dynamically crosslinked material of butyl rubber as the dispersed phase.

The thermoplastic polyester-based elastomers A and B were synthesized by the following method.

Thermoplastic polyester elastomer A

(1) Preparation of Polybutylene Terephthalate Copolymer

100 parts by mass of a terephthalic acid, 18.5 parts by mass of an isophthalic acid, 110 parts by mass of a 1,4-butanediol were put into a stainless autoclave provided with a stirrer, 56.5 mL of an n-butanol solution of Tetra-n-butyl Titanate monomer (68 g/L) was added, and these were stirred for 2.5 hours at normal pressure and at 180 to 220° C. to perform transesterification. After that, the pressure was reduced from the normal pressure to 130 Pa for 20 minutes at 220° C. to distill an excessive diol component, and polymerization was performed. After 1.5 hours passed, the contents were cooled and taken out to obtain an isophthalic acid copolymerized polybutylene terephthalate (polymer “a”). The number average molecular weight of the obtained polymer “a” was 38000.

(2) Preparation of Aliphatic Polycarbonatediol

100 parts by mass of an aliphatic polycarbonatediol (“Carbonatediol T6002”, molecular weight 2150, 1,6-hexanediol type manufactured by Asahi Kasei Chemicals Corporation) and 7.0 parts by mass of a diphenyl carbonate were respectively prepared, which were reacted at a temperature of 205° C. and 130 Pa. After two hours, the contents were cooled and taken out to obtain aliphatic polycarbonatediol (polymer “b”). The number average molecular weight of the obtained polymer “b” was 7500.

(3) Preparation of Thermoplastic Polyester Elastomer

100 parts by mass of the polymer “a” and 33 parts by mass of the polymer “b” prepared in the above method were stirred at 220 to 245° C., under 130 Pa, for 1.5 hours to perform transesterification reaction. After confirming that the resin became transparent, the contents were cooled and taken out. The amount of the hard segment contained in the obtained thermoplastic polyester elastomer was 75 mass %, and the amount of the isophthalic acid forming the hard segment was 15 mol %. A melting point was 187° C. and a Young's modulus was 180 MPa.

Thermoplastic Polyester Elastomer B

A thermoplastic polyester elastomer B′ in which the hard segment includes a butylene terephthalate unit and the soft segment includes aliphatic polycarbonatediol (1,6-hexandiol type) was obtained based on the method described in Example 1 of Japanese Patent No. 4244067. Separately, an isophthalic acid copolymerized polybutylene terephthalate (polymer “c”: the number average molecular weight was 22000) formed of terephthalic acid/isophthalic acid/1,4-butanediol (molar ratio 35/65/100) was obtained in the usual manner. After 25 parts by mass of the polymer “c” was added to 100 parts by mass of the thermoplastic polyester elastomer B′ and these materials were dry blended, the mixture was melted and kneaded by a TEM-26SS twin-screw extruder (manufactured by TOSHIBA MACHINE Co., Ltd) under conditions of a temperature 180 to 230° C. and a screw speed of 100 rpm to allow the transesterification reaction to proceed. The amount of the hard segment contained in the obtained thermoplastic polyester elastomer B was 75 mass %, the amount of the isophthalic acid forming the hard segment was 15 mol %. A melting point was 203° C. and a Young's modulus was 235 MPa.

Here, the number average molecular weight of the polymers “a”, “c” (polyester) and the polymer “b” (aliphatic polycarbonatediol) and melting points of the thermoplastic polyester elastomers A, B were measured by the following methods.

The number average molecular weight of Polyester (Mn):

0.05 g of polyester was dissolved in 25 ml of a mixed solvent (phenol/tetrachloroethane=6/4 (mass ratio)), and a reduced viscosity ηₛₚ/c at 30° C. was measured by using an Ostwald viscometer. Mn was calculated in accordance with the following formula by using the value of the measured reduced viscosity ηₛₚ/c.

ηₛₚ/c=1.019×10⁻⁴×Mn^{0.8928}−0.0167

The Number Average Molecular Weight of Aliphatic Polycarbonatediol (Mn):

An aliphatic polycarbonatediol sample was dissolved in Deuterated chloroform (CDCl₃) and ¹H-NMR was measured to calculate an end group, then, Mn was calculated by the following formula.

Mn=1000000/((end group amount(equivalent/ton))/2)

Melting Point (Tm) of Thermoplastic Polyester Elastomer

By using a differential scanning calorimeter DSC220C (2920 manufactured by TA Instruments Inc.), the thermoplastic polyester elastomer depressurized and dried at 50° C. for 15 hours was increased in temperature to 250° C. once and melted, then, cooled to 50° C., and increased in temperature to 20° C./minute again and measured to determine a peak temperature of an endothermic change by the melting as a melting point. As a measurement sample, 10 mg of the sample was measured in an aluminum pan (2920 manufactured by TA Instruments Inc.) to be in a sealed state by an aluminum lid (2920 manufactured by TA Instruments Inc.) and measured under a nitrogen atmosphere.

Using the obtained cylindrical film, the air permeation coefficient was measured, then, the breaking strength, a breaking elongation and the 10% modulus in the extrusion direction (tire width direction) and the direction perpendicular to the extrusion direction (tire circumferential direction) were measured by performing the tensile test. The results are shown in Table 1. The breaking elongation is a value measured based on the tensile test of JIS K6251 in the same manner as the breaking strength and the 10% modulus as described above, which is an elongation at the time of cutting at 23° C. (punched by No. 3 dumbbell). In Table 1, the orientation ratio in 10% modulus (M10) is represented by “M10 in the tire width direction”/“Ml 0 in the tire circumferential direction”, the orientation ratio in the breaking elongation (EB) is represented by “EB in the tire width direction”/“EB in the tire circumferential direction”, and the orientation ratio in the breaking strength (TB) is represented by “TB in the tire width direction”/“TB in the tire circumferential direction”.

Using the obtained cylindrical film, the tire formability and the tire durability were evaluated. An evaluation method is as follows.

Tire formability: the inflation experiment to a shape of the green tire was performed by winding the film around a tire forming drum. The experiment was performed 5 times. When at least one defective forming such as peeling occurred, evaluation was made as “X”, and when no defective forming occurred, evaluation was made as “◯”.

Tire durability: A steel radial tire 195/65R15 was fabricated by using the film as the inner liner, and a durability test was performed by a drum-type testing machine by using the obtained tire in conformity with conditions determined in Federal Motor Vehicle Safety Standards FMVS S139, the inner liner film on the inner surface of the tire was visually checked after the running test, then, a travelling distance until any defect such as a fracture, a crack or peeling was recognized was measured. The results are shown by index numbers in which the travelling distance measured when a normal rubber inner liner (thickness=0.6 mm) is used is set to 100. The larger the numeric value is, the longer the travelling distance to the defect detection is, which indicates that the durability is excellent.

### Comparative Examples 3, 4

A film having a thickness of 0.2 mm was extruded by a single-screw extruder to which a T-die was attached instead of performing the inflation molding. The used thermoplastic materials were the same as the above examples. Using the obtained film, the air permeation coefficient was measured and the tensile test was performed to measure the breaking strength, the breaking elongation and the 10% modulus in the extrusion direction and the direction perpendicular to the extrusion direction. Using the obtained film, the tire formability and the tire durability were evaluated. In Comparative Example 3, a cylindrical film was fabricate by bonding end portions by using heat sealing so that the extrusion direction (orientation direction) of the film becomes the tire width direction to be examined in the tests of tire formability test and tire durability. In Comparative Example 4, a cylindrical film was fabricated by bonding end portions by using heat sealing so that the extrusion direction (orientation direction) of the film becomes the tire circumferential direction to be examined in the tests of tire formability test and tire durability.

TABLE 1

| | | | | Comparative | Comparative | | Comparative | Comparative |
|---|---|---|---|---|---|---|---|---|
| | Example 1 | Example 2 | Example 3 | Example 1 | Example 2 | Example 4 | Example 3 | Example 4 |
| Film forming method | Inflation molding | | | | | | T-die molding | |
| Blow ratio | 1.2 | 1.5 | 1.8 | 1.0 | 3.0 | 1.5 | — | — |
| Taking-up speed (m/minute) | 6 | 6 | 6 | 6 | 6 | 6 | 1 | 1 |
| Film physical Properties | | | | | | | | |
| Air permeation coefficient (80° C.) × | 3.96 | 3.96 | 3.99 | Inflation | 3.98 | 3.85 | 3.95 | 3.92 |
| 10¹³(fm²/Pa · s) | | | | molding is not | | | | |
| Tire width direction | | | | available | | | | |
| 10% modulus (MPa) | 5.4 | 5.3 | 5.2 | | 5.0 | 5.8 | 5.5 | 4.8 |
| Breaking strength (MPa) | 19.9 | 19.5 | 19.5 | | 19.2 | 20.6 | 20.0 | 14.9 |
| Breaking elongation (%) | 470 | 460 | 460 | | 430 | 420 | 460 | 450 |
| Tire circumferential direction | | | | | | | | |
| 10% modulus (MPa) | 4.5 | 4.7 | 4.7 | | 4.8 | 4.9 | 4.7 | 5.5 |
| Breaking strength (MPa) | 14.0 | 14.3 | 14.4 | | 16.7 | 15.0 | 14.5 | 20.5 |
| Breaking elongation (%) | 460 | 460 | 450 | | 440 | 410 | 450 | 460 |
| Orientation ratio of 10% modulus | 1.2 | 1.13 | 1.11 | | 1.04 | 1.18 | 1.17 | 0.87 |
| Orientation ratio of breaking elongation | 1.02 | 1.0 | 1.02 | | 0.98 | 1.05 | 1.02 | 0.98 |
| Orientation ratio of breaking strength | 1.42 | 1.36 | 1.35 | | 1.15 | 1.37 | 1.38 | 0.73 |
| Evaluation | | | | | | | | |
| Tire formability | ◯ | ◯ | ◯ | — | X | ◯ | ◯ | X |
| Tire durability | 100 | 100 | 100 | — | 100 | 100 | 75 | 30 |

The results are as shown in Table 1. In Comparative Example 4, the film obtained by the T-die extrusion method was used. As the film was set so that the orientation direction of the film became the tire circumferential direction, the film was not easily expanded in the tire circumferential direction and the film was peeled off easily after the film expansion, therefore, the tire formability was inferior. In the tire durability test, a fracture extending in the tire circumferential direction occurred in the film of the inner liner in the vicinity of the shoulder portion, which reduced the durability. In Comparative Example 3, the film obtained by the T-die extrusion method was arranged so that the orientation direction became the tire width direction and the rigidity in the tire circumferential direction is low, therefore, the tire formability was good. As the orientation direction was the tire width direction, the generation of a fracture in the vicinity of the shoulder portion in the tire durability test did not occur. However, the cylindrical film has the joint, film peeling occurred at the joint in the tire durability test, therefore, the durability was inferior.

In Comparative Example 2, a cylindrical film having an orientation ratio of approximately “1” and obtained by inflation molding was used. As the film had no joint, the problem of durability due to the film peeling in the joint did not occur. However, as the rigidity of the tire circumferential direction was high, the film was not easily expanded in the tire circumferential direction and is easily peeled off after the film expansion, therefore, the tire formability was inferior.

On the other hand, the cylindrical film having the orientation ratio of from 1.35 to 1.80 obtained by the inflation molding was used in Examples 1 to 4, therefore, both the tire formability and the tire durability can be realized.

Some embodiments of the present invention have been explained as the above, and these embodiments were cited as examples, which do not intend to limit the scope of the invention. These novel embodiments can be achieved in other various forms and various omissions, replacements and alterations may occur within a scope not departed from the gist of the invention. These embodiments and modifications thereof are included in the scope and the gist of the invention as well as included in the inventions described in claims and a scope equivalent thereto.

### REFERENCE SIGNS LIST

1 . . . pneumatic tire, 3 . . . sidewall portion, 5 . . . shoulder portion, 9 . . . inner liner, 10 . . . cylindrical film, 12 . . . extrusion direction (orientation direction), 14 . . . tire width direction, 16 . . . direction perpendicular to extrusion direction, 18 . . . tire circumferential direction

1. A tire inner liner formed using a cylindrical film that comprises a thermoplastic material and is obtained by inflation molding,
wherein a ratio of breaking strength in a tire width direction to breaking strength in a tire circumferential direction of the cylindrical film is from 1.35 to 1.80.

2. The tire inner liner according to claim 1,
wherein the tire inner liner is obtained by the inflation molding with a blow ratio of from 1.2 to 1.8.

3. The tire inner liner according to claim 1,
wherein the cylindrical film is formed of a continuous phase of a thermoplastic elastomer and a dispersed phase of a rubber.

4. The tire inner liner according to claim 3,
wherein the thermoplastic elastomer comprises a hard segment comprising polybutylene terephthalate and a soft segment comprising aliphatic polycarbonate.

5. The tire inner liner according to claim 4,
wherein the hard segment comprises an isophthalic acid copolymerized polybutylene terephthalate.

6. The tire inner liner according to claim 3,
wherein the cylindrical film is formed by melting and kneading the thermoplastic elastomer and the rubber with a crosslinking agent so that the rubber is dynamically crosslinked by the crosslinking agent.

7. A pneumatic tire comprising:
the tire inner liner according to claim 1.

8. The pneumatic tire according to claim 7,
wherein the tire inner liner is arranged so that an orientation direction as an extrusion direction of the cylindrical film is parallel to the tire width direction in a tread portion and is parallel to a tire radial direction in a sidewall portion.

9. A method of manufacturing a pneumatic tire, comprising:
extruding and molding a cylindrical film in which a ratio of breaking strength in an extrusion direction to breaking strength in a direction perpendicular to the extrusion direction is from 1.35 to 1.80 by inflation molding using a thermoplastic material;
forming a green tire by placing the obtained cylindrical film on a forming drum so that the extrusion direction becomes a tire width direction; and
vulcanizing and molding the green tire.

10. The method of manufacturing the pneumatic tire according to claim 9,
wherein a blow ratio is set to from 1.2 to 1.8 when the cylindrical film is formed by the inflation molding.

11. The method of manufacturing the pneumatic tire according to claim 9,
wherein a taking-up speed of the cylindrical film extruded from an extruder at the time of the inflation molding is set to from 1 to 10 m/minute.

12. The method of manufacturing the pneumatic tire according to claim 9,
wherein a thermoplastic elastomer and a rubber are melted and kneaded with a crosslinking agent, and the rubber is dynamically crosslinked by the crosslinking agent to obtain the thermoplastic material including the thermoplastic elastomer as a continuous phase and the rubber as a dispersed phase.
